(19) United States
(12) Patent Application Publication
(10) Pub. No.: US 2003/0164611 A1
(43) Pub. Date: Sep. 4, 2003

(54) Antifalsification paper and security document produced therefrom

(76) Inventors: Walter Schneider, Miesbach (DE); Lars Hoffman, Freising (DE); Martin Loessl Zahedi, (US)

Correspondence Address: BACON & THOMAS, PLLC, 625 SLATERS LANE, FOURTH FLOOR, ALEXANDRIA, VA, 22314

(21) Appl. No.: 10/312,551

(22) PCT Filed: Jul. 4, 2001
(86) PCT No.: PCT/EP01/07652

(30) Foreign Application Priority Data
Jul. 5, 2000 (DE) 100-32-128.3

(51) Int. Cl. B42D 15/00

(52) U.S. Cl. 283/57

(57) ABSTRACT

The invention relates to a security paper for producing documents of value, such as bank notes, certificates, etc., with at least one multilayer security element. The security element is disposed at least partly on the surface of the security paper and has at least one visually checkable optical effect and at least one integrated circuit.

This invention relates to a security paper for producing documents of value, such as bank notes, certificates, etc., with at least one multilayer security element having at least one visually checkable optical effect, the security element being disposed at least partly on the surface of the security paper. The invention further relates to a multilayer security element and to a document of value with such a security element. A transfer material for applying a multilayer security element to a document of value and a method for producing the transfer material and the document of value are also the subject matter of the invention.

There is a constant interest in protecting papers of value against forgery and unauthorized reproduction. It is becoming ever more difficult, particularly in view of today's copying and printing techniques, to find effective security features that at least make unauthorized reproduction or forgery clearly recognizable, if they do not actually prevent it.

EP 0 019 191 B1 proposes for example providing a paper of value with an integrated circuit in which a checkable coding is written, the communication with the integrated circuit preferably being effected contactlessly via antennas. The integrated circuit is set in the gap of an at least partly metalized carrier foil. This foil is then laminated between two paper webs. Since the carrier foil is only laminated in between the two paper webs, however, there is the danger that the layers can be separated from each other relatively easily so that the plastic inlay provided with the chip can be used for possible forgeries. Further, this security element is a strictly machine-checkable security element that can only be checked by means of special detectors.

Frequently used authenticity features that are very easily visually checked and very striking are optically variable security elements, for example holograms, that show different visual impressions, such as color effects or information, from different viewing angles. A paper of value with such a security element is known from EP 0 440 045 A2. A bank note is described here that is provided with a label-like hologram. Since the optically variable effect of the hologram cannot be rendered by a color copier, these security elements offer very good protection against color copying. However, However, these security elements have the disadvantage that they are very poorly checkable by machine, since the radiation reflected by the diffraction structures of the hologram must be detected at certain solid angles and the influence of stray radiation largely excluded to permit reliable ascertainment of the presence of a certain hologram. A further problem is the fluctuating signal intensity, since the latter is greatly dependent on the illumination source of the hologram. For reliable measurement, defined lighting conditions must therefore be ensured.

To avoid this problem, it was therefore also proposed to superimpose a visually readily visible hologram with a strictly machine-readable laser transmission hologram (DE 38 40 037 C2). Readout of the machine-readable hologram can be effected only by means of a laser, the information hidden in this laser transmission hologram being projected onto a certain space coordinate in front of the document of value that is already defined when the hologram is recorded. The detector must be located at this place to permit this hidden information to be recognized. However, this type of visual and machine protection for a document of value is very elaborate both to produce and to check.

The invention is therefore based on the problem of proposing a document of value and a security paper with a security element having a visually checkable optical effect and also being checkable by machine, the security paper and document of value being preferably easy and cost-effective to produce.

This problem is solved by the features of the independent claims. Developments are the subject matter of the subclaims.

According to the invention, “security paper” designates the unprinted paper that can have not only the inventive security element but also further authenticity features, such as luminescent substances provided in the volume, a security thread or the like. It is usually present in quasi endless form and is processed further at a later time.

“Document of value” refers to a document that is finished for its intended use. It may be for example a printed paper of value, such as a bank note, certificate or the like, an ID card, a passport or another document requiring protection.

The invention will be described hereinafter with reference to the security paper. However, the advantages and embodiments apply analogously to documents of value.

According to the invention, the security paper is provided with at least one multilayer security element having an optical effect that can be easily checked visually and not rendered by copying technology, or only in falsified form. This security element is disposed at least partly on the surface of the security paper and contains at least one integrated circuit in one of its inside layers. This integrated circuit is for example a strict memory chip (ROM), a rewritable chip (EPROM, EEPROM) or a microprocessor chip. The chips used have a thickness of 5 microns to 50 microns, preferably 10 microns, and an edge length of about 0.1 millimeters to 3 millimeters, preferably 0.6 millimeters. On the chip there are preferably two to four contact surfaces.

The optical effect of the security element can be produced by a layer containing optically variable pigments, in particular interference-layer or liquid-crystal pigments. This layer can be present all over or in the form of information. Alternatively, the security element can also have a hologram, kinegram or other diffraction structure. Preferably, the diffraction structures are embossed into a plastic layer in the form of a relief structure. If the diffraction structures are to be observable in reflected light, they are combined with a reflecting layer, in particular a metal layer or a dielectric layer with a high refractive index. The reflecting layer need not be provided all over, however, but can be applied in the form of a screen or any other information. In particular, it can have gaps in the form of patterns or characters. A further possibility for producing a visually checkable optical effect is to use thin-film structures wherein metallic and/or dielectric layers with different refractive indexes are disposed one above the other, the layers cooperating so that different visual impressions arise at different viewing angles at least when viewed in reflected light. These different visual impressions are preferably different color effects.

Alternatively, the optical effect can also be produced by any printed image or a metallic layer with gaps in the form of patterns, characters or the like. The metal layer itself can likewise be present in the form of characters or patterns. The use of special printing inks, such as luminescent inks, is also possible. Of course, a plurality of security features producing an optical effect can also be used. When a layer producing an optical effect is spoken of below, this also refers to cooperating multilayer structures, such as the abovementioned dielectric thin-film elements or combinations of a plurality of layers that produce different optical effects. The term “hologram” is likewise intended to stand for any diffraction structures.

The inventive integrated circuit is preferably disposed between this layer having the optical effect and the security paper. It is thus protected outwardly from environmental influences and practically does not appear visually. It is advantageous to use integrated circuits with which communication is effected contactlessly via a coupling element. The coupling element can already be an integrated part of the integrated circuit or be disposed in a layer of the security element. Integration of the coupling element into the layer structure of the security element involves the advantage that in case of attempted manipulation or forgery the circuit cannot be separated operably from an original security element or a security paper equipped therewith, for example to be incorporated into a counterfeit reproduction. The coupling element can be a folded dipole, a coil or an open dipole. To increase the effectiveness of the system, the folded dipole or the coil can also have a metalized core zone. If the coupling element is formed on the layer producing the optical effect, the filled core zone also causes the visual impression of the layer to be less disturbingly influenced by the coupling element. The read range is between about 0.1 millimeters and a few centimeters depending on the type of coupling element and the selected read/write frequency, for example 13.56 megahertz and 2 gigahertz.

The inventive security element is preferably applied to the security paper after papermaking and is so connected with the security paper that it cannot be removed without destroying the security paper or the security element. The invention thus has the advantage that the security element does not have to be integrated into the papermaking process and is nevertheless connected with the paper of value in forgery-proof fashion. A further advantage is that the security element is protected against attempts at forgery in several respects. The optical effect of the layers facing the viewer cannot be rendered true to the original with copying machines or other reproduction tech-reproduction techniques, so that such attempts at forgery can already be visually recognized easily and fast. If an attempt to reproduce or imitate the optical impression of the security element should succeed, however, the forgery can nevertheless be recognized upon the machine check of the integrated circuit. Since the circuit is disposed inside the security element and covered by the layers producing the optical effect, a potential forger will not notice this additional authenticity feature and therefore not attempt to imitate it.

The inventive security element is preferably formed as a multilayer self-supporting label or as a transfer element that is connected with the security paper after its production. The contour form of the security element is freely selectable. Alternatively, the security element can also be formed as a security thread. In this case, the integrated circuit and the layer producing the optical effect are disposed on a thread-shaped plastic substrate that is so incorporated into the paper web during papermaking that the thread passes directly to the surface of the security paper in partial areas. According to a preferred embodiment, the security thread consists of two plastic substrates between which the integrated circuit and the layer producing the optical effect are disposed.

A “transfer element” refers according to the invention to a security element that is prepared on a separate carrier layer, for example a plastic foil, in the reverse order as it later comes to lie on the security paper, and then transferred to the security paper by means of an adhesive or lacquer layer in the desired contour forms. The carrier layer can be removed from the layer structure of the security element after transfer, or remain a firm part of the security element on the layer structure as a protective layer.

The individual transfer elements can be prepared on the carrier layer as separate individual elements in the contour forms to be transferred. Alternatively, the layer sequence of the transfer elements is provided on the carrier layer in continuous form. Such carrier layers with spaced-apart individual transfer elements or a continuously extending layer structure will hereinafter be referred to as “transfer material,” and the layer sequence of the security element disposed on the carrier layer as the “transfer layer.”

In the case of the continuous transfer layer, the transfer material is then connected with the security paper via an adhesive layer, and the adhesive layer activated via suitable embossing tools so that the transfer layer adheres to the security paper only in the activated areas. All other areas are then removed with the carrier layer. Alternatively, the adhesive layer can also be executed in the form of the security element to be transferred. Adhesives preferably used are hot-melt adhesives. However, any other adhesives, such as reaction lacquers, can also be used.

The security element can alternatively be applied to the document of value. The embodiments and fastening possibilities described in connection with the security paper apply analogously in this case.

Hereinafter, some preferred layer sequences of the inventive security element will be explained in more detail by the example of the transfer material.

The analogous layer sequence, only in the accordingly reverse order of layers, can of course also be used for labels and security threads.

In the simplest form, the transfer material consists of a carrier layer, in particular a transparent plastic foil, at least one layer producing the optical effect and at least one integrated circuit. In this embodiment the integrated circuit also contains the coupling element for communication with a read/write device.

If an integrated circuit not having an integrated coupling element is used, a suitable coupling element must be provided in the layer structure of the transfer layer of the transfer material. The transfer layer with the integrated coupling element is then preferably formed as a thin, non-self-supporting foil. This thwarts attempts at forgery that aim at detaching the original security element from a security paper, since the non-self-supporting security element is not removable without being damaged.

This coupling element can be an open dipole, a folded dipole or a coil. This coupling element is preferably produced by suitable demetalizings in a metal layer. For this purpose the carrier layer of the transfer material, which is optionally provided with a separation layer, is provided with the layer producing the optical effect. On this layer layer a water-soluble or other layer soluble by means of a solvent is then printed in the form of the areas to be demetalized. In the next step, the carrier layer is metalized completely on the printed side. In a last step, the soluble ink and the metalization present in these areas are removed. The integrated circuit is fastened to this layer by means of a conductive adhesive layer, for example conductive silver or an anisotropic conductive adhesive. Finally, the carrier layer is provided with an adhesive layer at least in certain areas.

Alternatively, the structuring of the metal layer can also be effected by means of known etching techniques. In this connection, the carrier layer is provided directly with the all-over metalization after application of the layer producing the optical effect. The metal layer is then printed with a protective lacquer layer in the form of the desired coupling element. The non-covered areas are then removed with suitable solvents. The protective layer can also be produced by photographic means by coating the metal layer all over with a photoresist that is then exposed and developed.

According to a variant, the metallic layer forming the coupling element can be separated from the layer producing the optical effect by an insulating layer. This is necessary in particular when the layer producing the optical effect likewise has a conductive layer.

According to a further embodiment of the invention, however, it is also possible that the metallic layer is at the same time required for the visually optical effect. If a reflection hologram is used for example, the layer producing the optical effect usually consists of an embossed lacquer layer in which the diffraction structures of the hologram are embossed in the form of a relief structure, and a metal layer. The carrier layer of the transfer material is first provided with the embossed lacquer layer in which the diffraction structures are embossed. This lacquer layer is then provided with a metal layer. Before the metal layer is preferably vapor-deposited, however, a soluble ink is printed on for producing the coupling element, as explained above. After metalization, the soluble ink is removed and the integrated circuit applied, as likewise described above. Here, too, the abovementioned etching techniques can alternatively be used for structuring the metal layer.

In this embodiment, the coupling element is to be recognized visually if the embossed lacquer layer, which forms the outermost layer facing the viewer in the finished security element, is transparent. If this effect is undesirable, the embossed lacquer layer can be colored. Preferably, metallic pigments are used for this purpose. Alternatively, the security element or security paper is laminated with a foil or provided with a print that hides the optical impression of the coupling element.

This variant has the additional advantage that the layers of the security element ensuring the optical effect are undetachably connected with the machine-checkable integrated circuit. Manipulations of the layers producing the optical effect thus simultaneously influence the machine-readable module.

However, the coupling element need not necessarily consist of an accordingly formed metal layer. It can also be formed by a conductive polymer layer that is accordingly printed for example.

The connection between coupling element and chip is effected in all embodiments either by electrically conductive connecting elements, such as conductive adhesives, tin-lead solder, etc., or contactlessly, e.g. capacitively.

To make sure that manipulation by punching out a circuit together with the coupling element from a security element or a security paper provided therewith is noticed, the coupling element is preferably designed to cover a large area. The resulting punched holes would already be very striking visually even to a layman as of an area assumed by the coupling element of 20 square millimeters or more.

The security paper provided with the inventive security elements can then be processed into any documents of value. If bank notes are produced from the security paper for example, the security paper is usually cut into sheets with a plurality of copies that can then be processed in suitable printing machines. Each copy has at least one inventive security element. In a preferred embodiment, the security element is formed as a strip extending parallel to one of the edges of a copy. This has the advantage that the security element can be transferred to the security paper in a continuous process.

During printing, the area of the security element can also be overprinted at least partially, thereby further increasing the forgery-proofness of the document of value, in particular if a tactile steel intaglio print is used for overprinting. However, the inventive security paper can also be used for producing other documents of value, such as passports, shares, visas, ID cards, certificates, admission tickets, accompanying documents for transportation, security labels or checks, etc. The documents of value can in turn be fastened as antiforgery elements to any products, such as CDs, perfumes, pharmaceutical products, packages of all types.

The forgery-proofness of the inventive document of value can be increased even further by storing certain data relevant to the document of value in the integrated circuit in checkable fashion. For example, the history of use of the document of value can be stored in the integrated circuit. With bank notes for example, information about their issue and further life can be stored, thus permitting a hitherto hardly possible evaluation of the circulation behavior of the notes. It is equally possible to store information about fitness or unfitness for circulation of bank notes.

Further, it is possible to mark or block documents of value for certain applications. Such marking could open up especially advantageous possibilities in dealing with blackmailing money.

In a special embodiment, the integrated circuit of the security element can be additionally equipped or connected with a photosensitive sensor that is likewise contained in the security paper or the security element and recognizes for example incident light, heat, magnetism and other properties. The measured values of such sensors are transmitted to the integrated circuit and stored there. This makes it possible for example to record each copying operation of a document as incident light and to store the number of copying operations in the integrated circuit. This offers the advantage of making it possible to distinguish between legal and illegal copies. When a legal copy is made, the user is aware that there is a corresponding sensor in the security paper so that he can then erase the information about his legal duplication using a device available only to him. Illegal duplication is not erased, however. If a check is done before each copying operation of whether the corresponding memory of the integrated circuit the integrated circuit has an entry, further copies can be prevented. This procedure is suitable in particular for documents that are usually stored sealed from light.

Alternatively, identification numbers of the individual copying machines can also be stored in the integrated circuit. This opens up the possibility that all machines used for producing copies can be identified at a later time. This can be useful when tracing forgers. Finally, copying machines can also be equipped with corresponding readers that prevent a copying operation of the document of value when reading a corresponding marking from the integrated circuit.

The integrated circuit can further be used for storing a type of electronic stamp of an issuing authority. This is of advantage in particular with visas or passports. For this purpose it is expedient to provide each document of value with individual information. This may be simple random numbers or more complex information which can include features peculiar to the document, such as special printing tolerances, transmission properties of the paper or the like. This information can further be encoded cryptographically.

However, the integrated circuit can also be used for protecting the legible information applied to the document of value. For example, if identification information such as a number and an indication of the issuer is entered on a document of value, the corresponding information can also be stored in the integrated circuit. Storage of this information is preferably effected in encrypted form that can only be identified with the matching counter key. Upon a check of the document of value, the information contained in the integrated circuit is compared with the information actually present legibly on the document.

If communication with the integrated circuit is effected contactlessly, the handling of such documents is relatively simple. They can then be used for example to perform a virtually complete check in connection with goods deliveries, border crossings and other operations by which flows of goods are handled together with documents. The invention can be used for example to check smuggling operations.

If a microprocessor is used as an integrated circuit, information encrypted by suitable cryptographic methods can moreover be produced in the integrated circuit of the security paper or document of value and transferred to a read/write device. Any other programs or multifunctional structures can also be used. Techniques known from data processing or from the field of smart-card technology can be used here.

Further examples and advantages of the invention will be explained with reference to the figures. It is pointed out that the figures are only for illustration and do not show the invention true to scale.

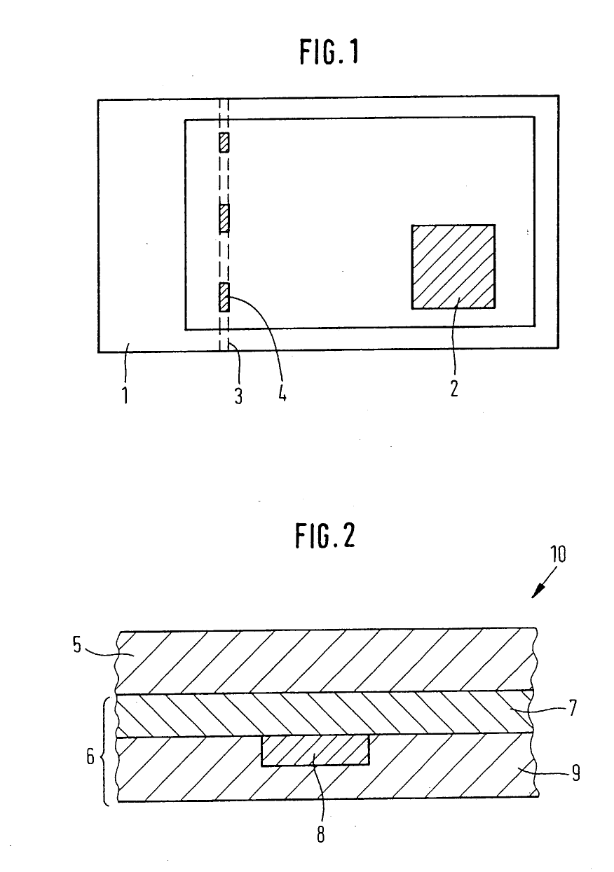

FIG. 1 shows an inventive document of value,

FIGS. 2 to 5 show different embodiments of the inventive transfer material in cross section,

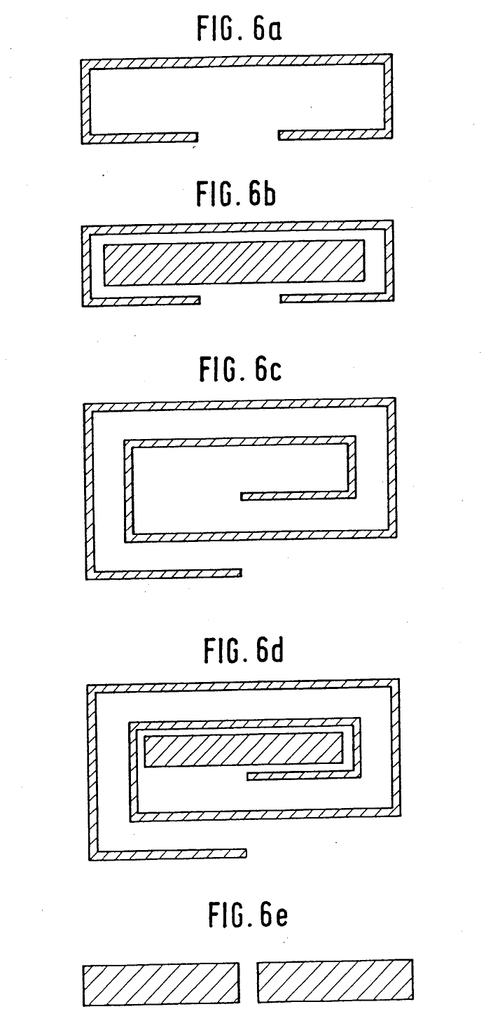

FIGS. 6a) to 6e) show different examples of the inventive coupling element.

FIG. 1 shows a variant of the inventive document of value in a top view. The example shown involves bank note 1 produced from the inventive security paper. The bank note bears inventive security element 2 executed as a transfer element and applied using the transfer material explained in more detail hereinafter. Bank note 1 can have additional security elements, for example security thread 3. Security thread 3 is quasi woven into the paper as a so-called “window security thread” so that it passes to the surface of the bank note in certain areas 4.

FIGS. 2 to 5 show different embodiments of inventive transfer material 10. Transfer material 10 consists fundamentally of carrier layer 5 and transfer layer 6 that is transferred to the inventive document of value at least in certain areas. In the case of security element 2 shown in FIG. 1, transfer layer 6 is detached from carrier layer 5 in the form of a square for example. Carrier layer 5 can be provided with a separation layer to guarantee defined detachment of the transfer layer. This separation layer is not shown in the figures. Any other contour forms are of course also possible, including filigree structures such as guilloches, etc. Security elements 2 frequently also have the form of strips disposed parallel to security thread 3.

Transfer layer 6 shown in FIG. 2 consists of layer 7 producing the optical effect, integrated circuit 8 and adhesive layer 9. Since integrated circuit 8 already has an integrated coupling element, no further layers for communication with the integrated circuit are to be provided in the layer structure of transfer layer 6. Layer 7 producing the optical effect is therefore freely selectable. However, it is preferably opaque at least in the area of integrated circuit 8 so that integrated circuit 8 is not recognizable visually.

Layer 7 producing the optical effect is shown all over here and can in turn be composed of a plurality of layers. This is the case for example if it is a thin-film element, which can be composed of a plurality of dielectric layers with different refractive indexes and thin metal layers. Such a layer structure produces an angle-dependent interplay of colors.

Layer 7 can also be any other layer producing an optical effect, for example a printed layer containing special pigments producing an optically variable effect. For this purpose liquid-crystal pigments or other pigments exploiting interference effects are preferably used, for example IRIODINE® from the Merck company.

Adhesive layer 9 serves to fasten security element 2 to the document of value. It is preferably a hot-melt adhesive layer that is activated with the aid of suitably formed hot-stamping dies. However, adhesive layer 9 can also be provided only in certain areas to already define the contour form of the transfer elements to be transferred on the transfer material. According to a further embodiment, it can also be completely absent. In this case the adhesive layer is applied in the desired form to the substrate that is to be provided with a transfer element.

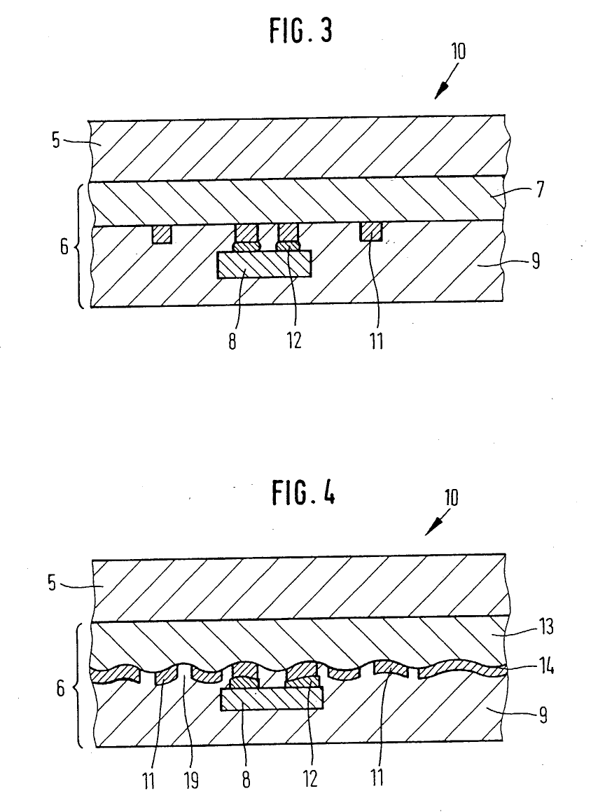

The transfer material shown in FIG. 3 is provided with an integrated circuit not having an integrated coupling element. Transfer layer 6 therefore contains not only allover layer 7 producing an optical effect but also metal layer 11. Metal layer 11 is applied in the form of a folded dipole, as shown in FIG. 6a), and forms the coupling element for integrated circuit 8. The connection between the terminals of folded dipole 11 and the contact areas of the integrated circuit is effected via conductive adhesive layer 12.

Transfer layer 6 shown in FIG. 4 has a hologram consisting of embossed layer 13 and metal layer 14. Metal layer 14 ensures that the relief-like diffraction structures of the hologram can be observed in reflected light. However, metal layer 14 has spaces 19. Spaces 19 are formed so as to result in coupling element 11 for integrated circuit 8. As in FIG. 3, the coupling element is formed by a folded dipole insulated from the rest of metal layer 14 by spaces 19.

In this example, metal layer 14 is simultaneously part of layer 7 producing the optical effect and of integrated circuit 8. However, coupling element 11 is to be clearly recognized in a top view if embossed layer 13 is of transparent design. If this effect is not desired, embossed layer 13 can be colored with translucent colors. It is also possible to use nonconductive, metallic-looking pigments that blur the optical impression of coupling element 12.

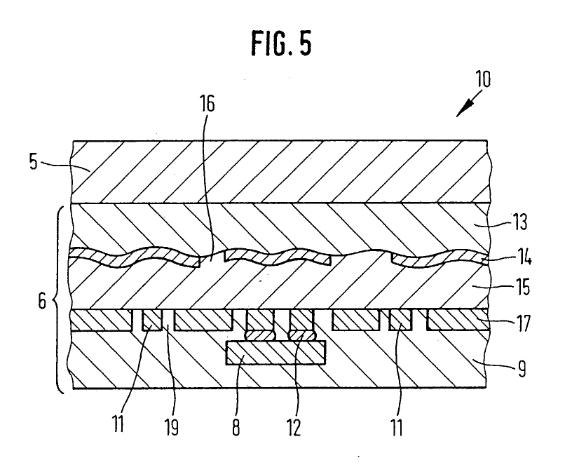

Transfer layer 6 shown in FIG. 5 likewise shows a hologram combined with an integrated circuit. In the present case, reflecting layer 14 of the diffraction structure does not serve simultaneously as a communication layer for integrated circuit 8. Rather, metal layer 14 is separated from metal layer 17 having coupling element 11 by insulating layer 15. Nevertheless, metal layer 14 has gaps 16 in the form of characters or patterns that are well readable at least in transmitted light. These gaps form a further visual authenticity feature.

Metal layer 17 containing coupling element 11 is constructed analogously to reflecting layer 14 shown in FIG. 4. That is, it has spaces 19 that insulate coupling element 11 from the rest of the metal layer.

Gaps 16 and spaces 19 in metal layers 14 and 17 can be produced in different ways. For example, the metal layers can be vapor-deposited by means of corresponding masks in the desired form directly on particular layer 13, 15. Alternatively, the metal layers can also be produced in a first step as all-over metal layers, which are then covered with a protective layer in the desired areas. The non-covered free areas are then removed with the aid of suitable solvents. These removed areas correspond to gaps 16 or spaces 19.

However, the method preferably used is to print layer 13, 15 in a first step with a preferably water-soluble ink in areas 16, 19. An all-over metalization is then applied by vapor deposition. In a last step, the soluble ink and the metal layer disposed thereabove are removed with a corresponding solvent so that gaps 16 or spaces 19 arise. It is likewise possible to produce gaps 16 using a different method from that for producing spaces 19.

The same methods can of course also be used for producing coupling element 11 as shown in FIG. 3.

FIG. 6 shows different embodiments of the coupling element. What is shown in each case is solely the coupling element as used for example in FIG. 3. Any further metallic surroundings possibly present, as shown in FIGS. 4 and 5, have been omitted for clarity's sake.

FIG. 6a) shows a folded dipole, which can additionally be provided with a metallic core to increase the power of the system, as shown in FIG. 6b). Alternatively, the coupling element can also be executed as a coil with a corresponding number of turns or with a metallic core, as shown in FIGS. 6c) and 6d). A further capacitively operable variant is shown in FIG. 6e). The two metallic bars act as an open dipole here. These forms of coupling elements can of course be used in all examples shown and described.

As explained above, these coupling elements are preferably produced by a corresponding metalization or demetalizing. However, they can alternatively be produced by printing technology with the aid of conductive polymers.

The layer structures of transfer material 10 shown in FIGS. 2 to 5 can be transferred analogously to a security thread. In this case, carrier layer 5 is replaced with a plastic foil undetachably connected with the layer structure disposed thereon. The layer structure here corresponds to transfer layers 6 shown. This security thread can be woven into the security paper analogously to security thread 3 shown in FIG. 1. However, the security thread can alternatively be disposed completely on the surface of the security paper or document of value. For this purpose the surface of the plastic carrier carrier opposite the layer structure is coated with a suitable adhesive. Analogously, it is possible to produce the security element as a self-supporting adhesive label with any contour form.

1. A security paper for producing documents of value, such as bank notes, certificates, etc., with at least one multilayer security element having at least one visually checkable optical effect, the security element being disposed at least partly on the surface of the security paper, characterized in that the security element has at least one integrated circuit.

2. A security paper according to claim 2, characterized in that the security element shows an optically variable effect whereby the security element produces different visual impressions at different viewing angles.

3. A security paper according to claim 1 or 2, characterized in that the security element has at least one layer containing optically variable pigments, in particular interference-layer or liquid-crystal pigments.

4. A security paper according to at least one of claims 1 to 3, characterized in that the security element has at least one layer in which diffraction structures in the form of a relief structure are present.

5. A security paper according to claim 4, characterized in that the diffraction structures are combined at least in certain areas with a reflecting layer, in particular a metal layer or a dielectric layer with a high refractive index.

6. A security paper according to at least one of claims 1 to 5, characterized in that the security element has at least a metallic and a dielectric layer or at least two dielectric layers with different refractive indexes, the layers cooperating so that different visual impressions arise when viewed in reflected light at different viewing angles.

7. A security paper according to at least one of claims 1 to 6, characterized in that the integrated circuit is disposed between the layers having the optical effect and the security paper.

8. A security paper according to at least one of claims 1 to 7, characterized in that the energy supply for the integrated circuit is effected contactlessly via a coupling element.

9. A security paper according to claim 8, characterized in that the coupling element is part of the integrated circuit.

10. A security paper according to claim 8, characterized in that the coupling element is disposed in a layer of the security element.

11. A security paper according to claim 10, characterized in that the integrated circuit is connected with the coupling element.

12. A security paper according to claim 10 or 11, characterized in that the security element has at least one metallic layer in which the coupling element is formed.

13. A security paper according to claim 12, characterized in that the metallic layer is separated from the layers producing the optical effect by an insulating layer.

14. A security paper according to claim 12, characterized in that the metallic layer is at the same time one of the layers producing the optical effect.

15. A security paper according to at least one of claims 8 to 14, characterized in that the coupling element is a folded dipole, a coil or an open dipole.

16. A security paper according to claim 15, characterized in that the folded dipole or the coil has a metalized core zone.

17. A security paper according to at least one of claims 1 to 16, characterized in that the integrated circuit is a memory chip or a microprocessor chip.

18. A security paper according to at least one of claims 1 to 17, characterized in that the security element is a transfer element or a label disposed completely on the surface of the security paper.

19. A security paper according to claim 18, characterized in that the security element has the form of a strip.

20. A security paper according to at least one of claims 1 to 17, characterized in that the security element is a security thread.

21. A security paper according to at least one of claims 8 to 19, characterized in that the coupling element occupies an area of at least 20 square millimeters.

22. A security paper according to at least one of claims 1 to 21, characterized in that the security element is so connected with the security paper that they cannot be separated nondestructively.

23. A document of value with at least one multilayer security element having at least one visually checkable optical effect, the security element being disposed completely on the surface of the document of value, characterized in that the security element has at least one integrated circuit.

24. A document of value according to claim 23, characterized in that the document of value is a passport, a bank note or a credit card.

25. A document of value according to claim 23 or 24, characterized in that the document of value has a security paper according to at least one of claims 1 to 22.

26. A document of value according to at least one of claims 23 to 25, characterized in that the document of value has a print, in particular an intaglio print, at least overlapping with the security element.

27. A multilayer security element for application to a document of value having at least one visually checkable optical effect, characterized in that the security element has at least one integrated circuit.

28. A transfer material for applying a multilayer security element to a document of value, the transfer material having at least one visually checkable optical effect, characterized in that the transfer material has at least one integrated circuit.

29. A transfer material according to claim 28, characterized in that the transfer material has the following layer structure:
a carrier layer,
at least one layer producing the optical effect, and
at least one integrated circuit.

30. A transfer material according to claim 29, characterized in that the layer producing the optical effect is a printed layer containing optically variable pigments, in particular interference-layer or liquid-crystal pigments.

31. A transfer material according to at least one of claims 28 to 30, characterized in that the transfer material has the following layer structure:
a carrier layer,
a layer in which diffraction structures in the form of a relief structure are present,
a metal layer in which a coupling element is formed,
an integrated circuit, and
a hot-melt adhesive layer.

32. A transfer material according to at least one of claims 28 to 30, characterized in that the transfer material has the following layer structure:
a carrier layer,
a layer in which diffraction structures in the form of a relief structure are present,
a reflecting layer permitting the diffraction structures to be observed in reflected light,
an insulating layer,
a metal layer in which a coupling element is formed,
an integrated circuit, and
a hot-melt adhesive layer.

33. A transfer material according to claim 31 or 32, characterized in that the integrated circuit is connected with the coupling element via a conductive adhesive layer.

34. A transfer material according to claim 33, characterized in that the conductive adhesive layer is a conductive silver layer or an anisotropic conductive adhesive layer.

35. A transfer material according to at least one of claims 28 to 34, characterized in that the coupling element is a folded dipole, a coil or an open dipole.

36. A transfer material according to at least one of claims 28 to 35, characterized in that the integrated circuit is a memory chip or a microprocessor chip.

37. A transfer material according to at least one of claims 29 to 34, characterized in that the transfer layer of the transfer material is formed as a non-self-supporting foil.

38. A method for producing a transfer material for applying a multilayer security element to a document of value, the transfer material having at least one visually checkable optical effect, characterized in that at least one integrated circuit is incorporated into the layer structure of the transfer material.

39. A method according to claim 38, characterized by the following steps:
a) providing a carrier layer,
b) applying at least one layer producing an optical effect,
c) vapor-depositing a metallic layer, a coupling element being formed in the metallic layer,
d) applying an integrated circuit.

40. A method according to claim 39, characterized in that before step c) a soluble ink is printed on in the form of the coupling element and any further patterns or characters, and that after step c) said ink is removed together with the metallic layer.

41. A method according to claim 39 or 40, characterized in that the integrated circuit and the coupling element are interconnected via a conductive silver layer or an anisotropic conductive adhesive layer.

42. A method according to at least one of claims 39 to 41, characterized in that in step b) a layer is applied into which diffraction structures in the form of a relief structure are then embossed.

43. A method according to claim 42, characterized in that in step c) a UV-curable lacquer layer is applied that is cured during the embossing operation.

44. A method according to claim 42 or 43, characterized in that in step b) a reflecting layer is applied to the embossed layer at least in certain areas.

45. A method according to at least one of claims 39 to 41, characterized in that in step b) at least a metallic and a dielectric layer or at least two dielectric layers with different refractive indexes are applied, the layers cooperating so that different visual impressions arise when viewed in reflected light at different viewing angles.

46. A method according to at least one of claims 39 to 45, characterized in that an insulating layer is disposed between the layers producing the optical effect and the metal layer to be applied in step c).

47. A method according to at least one of claims 39 to 45, characterized in that in a step e) an adhesive layer, preferably a hot-melt adhesive layer, is applied.

48. A method for producing a document of value with a security element, characterized in that the layer structure of the transfer material according to at least one of claims 28 to 37 is transferred to the document of value in certain areas and the carrier layer is then removed.

49. Use of the transfer material according to at least one of claims 28 to 37 for producing security elements.

50. Use of the security paper according to at least one of claims 1 to 22 for protecting products.

51. Use of the document of value according to at least one of claims 23 to 26 for protecting products.
